(19) United States
(12) Patent Application Publication
(10) Pub. No.: US 2025/0050281 A1
(43) Pub. Date: Feb. 13, 2025

(54) Preparation Method of Nanofiltration Membrane with Tree-Like Structure and Use

(71) Applicant: Fuzhou University, Fuzhou City (CN)

(72) Inventors: Yan YU, Fuzhou City (CN); Wenxiu GAN, Fuzhou City (CN); Ziyang ZHENG, Fuzhou City (CN); Feifei CHEN, Fuzhou City (CN)

(21) Appl. No.: 18/780,160

(22) Filed: Jul. 22, 2024

(30) Foreign Application Priority Data
Aug. 10, 2023 (CN) 202311005315.0

(51) Int. Cl. B01D 67/00; B01D 61/02; B01D 71/02; B01D 71/10

(52) U.S. Cl. CPC B01D 67/0051; B01D 61/027; B01D 67/0079; B01D 71/02; B01D 71/10; B01D 2323/081

(57) ABSTRACT

Provided are a preparation method of a nanofiltration membrane with a tree-like structure and use. The preparation method includes: taking a cellulose fiber filter paper as a substrate, and allowing hydroxyapatite nanowire arrays to grow in situ through solvothermal synthesis to obtain a composite filter paper; and repeatedly soaking the composite filter paper in a solution of trimesic acid and iron chloride in ethanol to allow continuous deposition to obtain the nanofiltration membrane with the tree-like structure. The nanofiltration membrane with the tree-like structure of the present application has a larger surface roughness and a larger specific surface area than the conventional nanofiltration membranes, and thus exhibits a very high interception rate (higher than 94%) for anionic/cationic dyes and heavy metal ions Pb²⁺. Therefore, the nanofiltration membrane with the tree-like structure of the present application has excellent environmental benefits.

### CROSS REFERENCE TO RELATED APPLICATION

This patent application claims the benefit and priority of Chinese Patent Application No. 202311005315.0, filed with the China National Intellectual Property Administration on Aug. 10, 2023, the disclosure of which is incorporated by reference herein in its entirety as part of the present application.

### TECHNICAL FIELD

The present disclosure belongs to the field of membrane-based water treatments, and specifically relates to a preparation method of a nanofiltration membrane with a tree-like structure, and a use thereof in a field of water purification.

### BACKGROUND

The arbitrary discharge of industrial wastewater, agricultural wastewater, and domestic wastewater makes the water pollution increasingly heavy. According to the data of the United Nations World Water Development Report (WWDR), 80% of wastewater worldwide is discharged directly without being treated, such that nearly 2.1 billion people are forced to drink polluted water. As a livelihood issue, the safety of drinking water needs to be solved urgently. The membrane separation-based water purification technology has become the mainstream water treatment technology due to advantages such as low energy consumption, easy operation, and high effluent water quality. The membrane-based water treatment has advantages such as low energy consumption, easy operation, small floor space, and high effluent water quality. The development of a high-performance and low-cost membrane separation technology is one of the main research fields of eco-materials science at present and in the future. Nanofiltration membranes have an ability to separate metal ions of small-molecule organic matters, and are widely used in water treatments such as seawater desalination, water resource regeneration, drug separation, concentrated juice, dairy product treatment, and solvent recovery and fields such as food industry and biomedicine.

Currently, a nanofiltration membrane is prepared by attaching a polymer separation layer to a support layer. The existing nanofiltration membranes have the following shortcomings: (1) A separation layer is attached to a support layer horizontally, which is easy to cause problems such as agglomeration, low specific surface area, and slow mass transfer. (2) The actual wastewater includes both positively-charged heavy metal ions and negatively-charged or positively-charged organic matters, and the existing nanofiltration membranes are difficult to effectively remove organic matters and heavy metal ions with different properties. Therefore, how to solve the bottleneck problem faced by nanofiltration membranes and design and develop a novel nanofiltration membrane capable of efficiently removing organic matters and heavy metal ions is the difficult point of research in the current field of membrane separation.

The present disclosure makes a breakthrough based on the existing preparation process for nanofiltration membranes, and designs a novel composite nanofiltration membrane with reference to the bionic concept. The bionic design concept is as follows: A forest system has a self-purification ability. Organizational structures of the forest system include tree roots, tree trunks, tree branches, and tree leaves, which have respective functions. The tree roots have a wind-break and sand-fixing effect, and provide a stable support for the tree trunks, tree branches, and tree leaves. The tree trunks, tree branches, and tree leaves can intercept most of the rainfall, dust, and toxic particles to play a filtering role. The tree leaves can also absorb harmful sulfur dioxide and carbon dioxide gases. In addition, gaps among trees allow the passage of sunlight, the circulation of air, and the circulation of moisture. In other words, through the multi-level and orderly compounding of components with different functions, a forest ecosystem can not only efficiently filter out harmful substances, but also allow the selective passage of specific substances.

Inspired by the forest ecosystem, the present disclosure proposes a novel composite nanofiltration membrane prepared as follows: a cellulose fiber filter paper is taken as a substrate, hydroxyapatite nanowire arrays are allowed to grow on the cellulose fiber filter paper, and then metal-organic framework (MOF) nanocrystals are deposited on the hydroxyapatite nanowire arrays. In the novel composite nanofiltration membrane, cellulose fibers serve as tree roots, hydroxyapatite nanowire arrays serve as tree trunks, and MOF nanocrystals serve as tree leaves, so as to form a tree-like structure with a three-dimensional network, which can effectively improve a specific surface area and promote the mass transfer. In addition, the novel composite nanofiltration membrane integrates the ion exchange performance of hydroxyapatite and the high adsorption of MOF nanocrystals, which can allow the efficient removal of organic matters and heavy metal ions in wastewater.

### SUMMARY

In order to solve the key problems of the conventional horizontal nanofiltration membranes, the present disclosure prepares a nanofiltration membrane with a tree-like structure. In the present disclosure, a cellulose fiber/hydroxyapatite nanowire array composite filter paper is first prepared, and then MOF nanocrystals are well dispersed on a surface of hydroxyapatite nanowires, which can effectively improve the surface roughness and specific surface area. In addition, hydroxyapatite has ion exchange performance and can effectively intercept heavy metal ions. In the novel composite nanofiltration membrane, cellulose fibers serve as tree roots, hydroxyapatite nanowire arrays serve as tree trunks, and MOF nanocrystals serve as tree leaves, so as to produce the nanofiltration membrane with a tree-like structure. The high-performance nanofiltration membrane is obtained due to a tree root-tree trunk-tree leaf synergistic effect.

To allow the above objective, the present disclosure adopts the following technical solutions:
(1) weighing appropriate amounts of oleic acid and ethanol, thoroughly mixing the oleic acid and the ethanol under mechanical stirring to obtain a first mixed solution, adding a calcium chloride dihydrate aqueous solution, a sodium hydroxide aqueous solution, and a sodium phosphate monobasic dihydrate aqueous solution successively to the first mixed solution to obtain a second mixed solution, and thoroughly mixing the second mixed solution under mechanical stirring to obtain a solvothermal reaction solution;
(2) placing a cellulose fiber filter paper in a Teflon reactor, pouring the solvothermal reaction solution obtained in the step (1) into the Teflon reactor, allowing a solvothermal reaction to obtain a first composite filter paper, and ultrasonically cleaning the first composite filter paper with ethanol to obtain a second composite filter paper;
(3) soaking the second composite filter paper obtained in the step (2) in a specified volume of a solution of 1,3,5-benzenetricarboxylic acid in ethanol at a specified temperature for a specified time to obtain a third composite filter paper; taking the third composite filter paper out, and rinsing the third composite filter paper with ethanol to obtain a fourth composite filter paper; soaking the fourth composite filter paper in a specified volume of a solution of ferric chloride hexahydrate in ethanol at a specified temperature for a specified time to obtain a fifth composite filter paper; and taking the fifth composite filter paper out, and rinsing the fifth composite filter paper with ethanol; and continuously repeating the above single-time deposition to obtain nanofiltration membranes with different MOF loads.

Further, in the step (1), a mass ratio of the oleic acid to the ethanol is 5:7, a concentration of the calcium chloride dihydrate aqueous solution is 0.05 mol/L to 0.2 mol/L, a concentration of the sodium hydroxide aqueous solution is 0.5 mol/L to 1.5 mol/L, and a concentration of the sodium phosphate monobasic dihydrate aqueous solution is 0.15 mol/L to 0.25 mol/L.

Further, in the step (2), the solvothermal reaction is conducted at 150° C. to 250° C. for 10 h to 36 h.

Further, in the step (3), the solution of 1,3,5-benzenetricarboxylic acid in ethanol and the solution of ferric chloride hexahydrate in ethanol cach have a concentration of 0.005 mol/L to 0.02 mol/L and cach are used in a volume of 10 mL to 30 mL, the soaking in each of the solutions is conducted at 20° C. to 80° C. for 10 min to 60 min, and the above single-time deposition is repeated 5 times to 20 times.

The present disclosure has the following beneficial effects:
(1) The present disclosure innovatively proposes a design strategy of a nanofiltration membrane with a tree-like structure, where MOF nanocrystals are cleverly dispersed on hydroxyapatite nanowire arrays. Properties of the nanofiltration membrane with the tree-like structure are far better than properties of the conventional nanofiltration membrane with a horizontal MOF structure.
(2) The nanofiltration membrane with the tree-like structure prepared by the present disclosure integrates an electrostatic interaction, hydrogen bonding, a π-π interaction, and an ion exchange to exhibit an extremely-high interception rate for positively-charged dyes, negatively-charged dyes, and heavy metal ions.

### BRIEF DESCRIPTION OF THE DRAWINGS

FIGS. 1A-1B show scanning electron microscopy (SEM) images of the nanofiltration membranes prepared in Example 1 and Comparative Example 1;

FIGS. 2A-2B show atomic force microscopy images of the nanofiltration membranes prepared in Example 1 and Comparative Example 1;

FIG. 3 shows N₂ adsorption-desorption isotherms of the nanofiltration membranes prepared in Example 1 and Comparative Example 1;

FIG. 4 shows the comparison of interception rates of the nanofiltration membranes prepared in Examples 1 to 3 for Congo red;

FIGS. 5A-5D show the comparison of interception rates of the nanofiltration membranes prepared in Example 1 and Comparative Example 1 for the anionic dyes of Congo red and alizarin red and the cationic dyes of methylene blue and alkali blue 6B; and

FIG. 6 shows the comparison of interception rates of the nanofiltration membranes prepared in Example 1 and Comparative Example 1 for Pb²⁺ ions.

### DETAILED DESCRIPTION OF THE EMBODIMENTS

In order to make the objectives, technical solutions, and advantages of the present disclosure clear, the present disclosure is further described in detail below with reference to the accompanying drawings and embodiments. It should be understood that the specific embodiments described herein are merely intended to explain the present disclosure, rather than to limit the present disclosure. Further, the technical features involved in the various embodiments of the present disclosure described below may be combined with each other as long as they do not conflict with each other.

### Example 1

(1) Under mechanical stirring, 20 mL of an aqueous solution including 0.294 g of calcium chloride dihydrate was added to a mixed solvent of 60 g of oleic acid and 84 g of ethanol to obtain a first mixed solution, and the first mixed solution was thoroughly stirred for 20 min to obtain a second mixed solution. 20 mL of an aqueous solution including 1 g of sodium hydroxide was added to the second mixed solution to obtain a third mixed solution, and the third mixed solution was thoroughly stirred for 20 min to obtain a fourth mixed solution. 10 mL of an aqueous solution including 0.281 g of sodium phosphate monobasic dihydrate was added to the fourth mixed solution to obtain a fifth mixed solution, and the fifth mixed solution was thoroughly stirred for 20 min to obtain a reaction solution.

(2) A cellulose fiber filter paper was placed in a Teflon reactor, the reaction solution obtained in the step (1) was poured into the Teflon reactor, and the Teflon reactor was sealed and then placed in an oven to allow a reaction at 180° C. for 24 h to obtain a first composite filter paper. The first composite filter paper was ultrasonically cleaned in ethanol to remove residues on a surface, and then dried at 60° C. to obtain a second composite filter paper.

(3) 15 mL of a solution of 1,3,5-benzenetricarboxylic acid in ethanol (dissolubility: 0.01 mol/L) was added to a glass ware, and the second composite filter paper obtained in the step (2) was soaked in the solution of 1,3,5-benzenetricarboxylic acid in ethanol at 60° C. for 30 min, then taken out, rinsed with ethanol to remove residues on a surface, then soaked in 15 mL of a solution of ferric chloride hexahydrate in ethanol (dissolubility: 0.01 mol/L) at 60° C. for 30 min, taken out, and rinsed with ethanol to remove residues on a surface. The above deposition process was repeated 10 times to obtain a nanofiltration membrane with a tree-like structure.

### Comparative Example 1

15 mL of a solution of 1,3,5-benzenetricarboxylic acid in ethanol (dissolubility: 0.01 mol/L) was added to a glass ware, and a cellulose fiber filter paper was soaked in the solution of 1,3,5-benzenetricarboxylic acid in ethanol at 60° C. for 30 min, then taken out, rinsed with ethanol to remove residues on a surface, then soaked in 15 mL of a solution of ferric chloride hexahydrate in ethanol (dissolubility: 0.01 mol/L) at 60° C. for 30 min, taken out, and rinsed with ethanol to remove residues on a surface. The above deposition process was repeated 10 times to obtain a conventional horizontal nanofiltration membrane.

### Example 2

(1) Under mechanical stirring, 20 mL of an aqueous solution including 0.294 g of calcium chloride dihydrate was added to a mixed solvent of 60 g of oleic acid and 84 g of ethanol to obtain a first mixed solution, and the first mixed solution was thoroughly stirred for 20 min to obtain a second mixed solution. 20 mL of an aqueous solution including 1 g of sodium hydroxide was added to the second mixed solution to obtain a third mixed solution, and the third mixed solution was thoroughly stirred for 20 min to obtain a fourth mixed solution. 10 mL of an aqueous solution including 0.281 g of sodium phosphate monobasic dihydrate was added to the fourth mixed solution to obtain a fifth mixed solution, and the fifth mixed solution was thoroughly stirred for 20 min to obtain a reaction solution.

(2) A cellulose fiber filter paper was placed in a Teflon reactor, the reaction solution obtained in the step (1) was poured into the Teflon reactor, and the Teflon reactor was sealed and then placed in an oven to allow a reaction at 180° C. for 24 h to obtain a first composite filter paper. The first composite filter paper was ultrasonically cleaned in ethanol to remove residues on a surface, and then dried at 60° C. to obtain a second composite filter paper.

(3) 15 mL of a solution of 1,3,5-benzenetricarboxylic acid in ethanol (dissolubility: 0.01 mol/L) was added to a glass ware, and the second composite filter paper obtained in the step (2) was soaked in the solution of 1,3,5-benzenetricarboxylic acid in ethanol at 60° C. for 30 min, then taken out, rinsed with ethanol to remove residues on a surface, then soaked in 15 mL of a solution of ferric chloride hexahydrate in ethanol (dissolubility: 0.01 mol/L) at 60° C. for 30 min, taken out, and rinsed with ethanol to remove residues on a surface. The above deposition process was repeated 5 times to obtain a nanofiltration membrane with a tree-like structure.

### Example 3

(1) Under mechanical stirring, 20 mL of an aqueous solution including 0.294 g of calcium chloride dihydrate was added to a mixed solvent of 60 g of oleic acid and 84 g of ethanol to obtain a first mixed solution, and the first mixed solution was thoroughly stirred for 20 min to obtain a second mixed solution. 20 mL of an aqueous solution including 1 g of sodium hydroxide was added to the second mixed solution to obtain a third mixed solution, and the third mixed solution was thoroughly stirred for 20 min to obtain a fourth mixed solution. 10 mL of an aqueous solution including 0.281 g of sodium phosphate monobasic dihydrate was added to the fourth mixed solution to obtain a fifth mixed solution, and the fifth mixed solution was thoroughly stirred for 20 min to obtain a reaction solution.

(2) A cellulose fiber filter paper was placed in a Teflon reactor, the reaction solution obtained in the step (1) was poured into the Teflon reactor, and the Teflon reactor was sealed and then placed in an oven to allow a reaction at 180° C. for 24 h to obtain a first composite filter paper. The first composite filter paper was ultrasonically cleaned in ethanol to remove residues on a surface, and then dried at 60° C. to obtain a second composite filter paper.

(3) 15 mL of a solution of 1,3,5-benzenetricarboxylic acid in ethanol (dissolubility: 0.01 mol/L) was added to a glass ware, and the second composite filter paper obtained in the step (2) was soaked in the solution of 1,3,5-benzenetricarboxylic acid in ethanol at 60° C. for 30 min, then taken out, rinsed with ethanol to remove residues on a surface, then soaked in 15 mL of a solution of ferric chloride hexahydrate in ethanol (dissolubility: 0.01 mol/L) at 60° C. for 30 min, taken out, and rinsed with ethanol to remove residues on a surface. The above deposition process was repeated 15 times to obtain a nanofiltration membrane with a tree-like structure.

### Performance Evaluation

1. The nanofiltration membranes prepared in the examples and comparative example each were subjected to an organic pollutant separation test, and specific steps were as follows:
(1) Aqueous solutions of Congo red, alizarin red, methylene blue, and alkali blue 6B that cach had a concentration of 10 ppm were prepared, and the absorbance of each of the aqueous solutions was determined with an ultraviolet-visible spectrophotometer and was denoted as C₀.
(2) A nanofiltration membrane was placed in a sample holder, a syringe with 7 mL of a dye solution was connected to the sample holder, and the dye solution was allowed to pass through the filter membrane by a microsyringe pump with a flow rate set to 30 mL/h.
(3) After the dye solution totally passed through the filter membrane, the absorbance of a resulting filtrate was determined by an ultraviolet-visible spectrophotometer and was denoted as Cₜ. A dye interception rate was calculated according to the following formula:

$$interception rate = ( 1 - {C}_{t} / {C}_{0} ) \times 100 \% .$$

2. The nanofiltration membranes prepared in the examples and comparative example each were subjected to a heavy metal ion separation test, and specific steps were as follows:
(1) A lead nitrate aqueous solution with a desired Pb²⁺ ion concentration of 10 ppm was prepared, and an actual concentration of the lead nitrate aqueous solution was determined by an atomic absorption spectrophotometer and was denoted as C₀.
(2) A nanofiltration membrane was placed in a sample holder, a syringe with 7 mL of a Pb²⁺ ion solution was connected to the sample holder, and the Pb²⁺ ion solution was allowed to pass through the filter membrane by a microsyringe pump with a flow rate set to 15 mL/h.
(3) After the Pb²⁺ ion solution totally passed through the filter membrane, a concentration of a resulting filtrate was determined by an atomic absorption spectrophotometer and was denoted as Cₜ. A Pb²⁺ ion interception rate was calculated according to the following formula:

$$interception rate = ( 1 - {C}_{t} / {C}_{0} ) \times 100 \% .$$

### Result Analysis

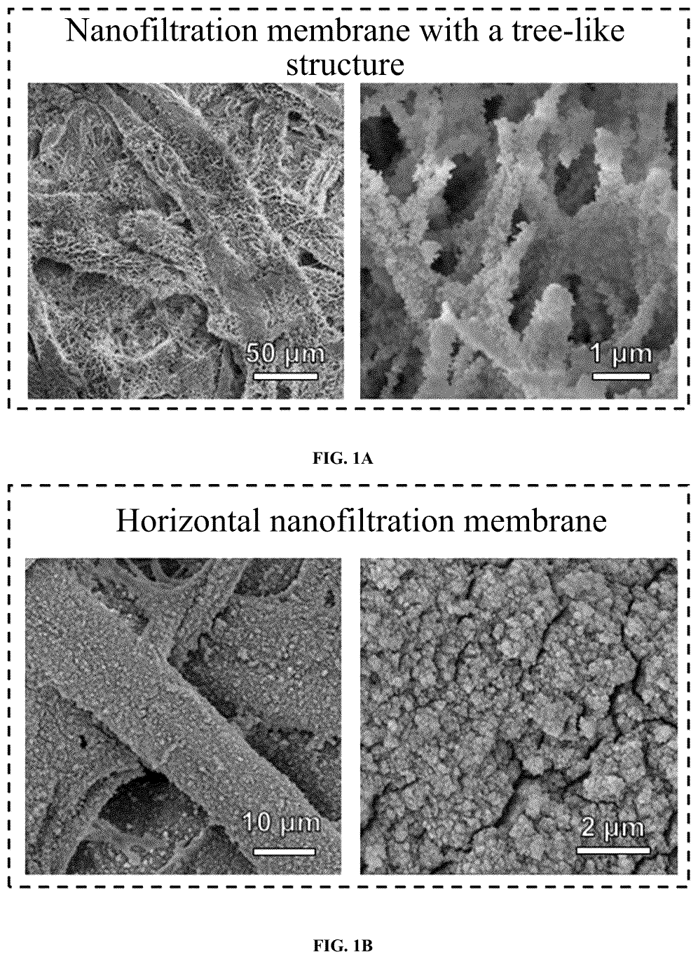

FIGS. 1A-1B show SEM images of the nanofiltration membrane with the tree-like structure in Example 1 and the nanofiltration membrane with a horizontal MOF structure in Comparative Example 1. According to this figure: Hydroxyapatite nanowire arrays grow vertically on a surface of cellulose fibers, and MOF nanocrystals are evenly dispersed on a surface of hydroxyapatite nanowires, so as to produce the nanofiltration membrane with the unique tree-like structure. In the absence of hydroxyapatite nanowire arrays, MOF nanocrystals are severely agglomerated on a surface of cellulose fibers to produce the conventional horizontal nanofiltration membrane.

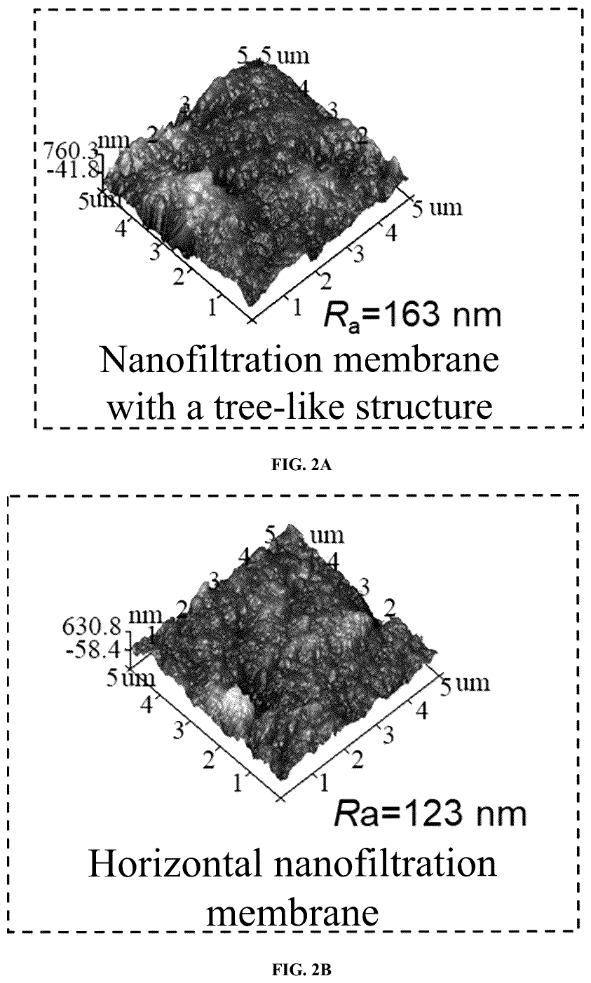

FIGS. 2A-2B show atomic force microscopy images of the nanofiltration membrane with the tree-like structure in Example 1 and the horizontal nanofiltration membrane in Comparative Example 1. It can be seen from this figure that the nanofiltration membrane with the tree-like structure has a large average surface roughness of 163 nm and the horizontal nanofiltration membrane has a small average surface roughness merely of 123 nm. The greater the average surface roughness, the better the contact between a pollutant and a filter membrane and thus the higher the interception rate.

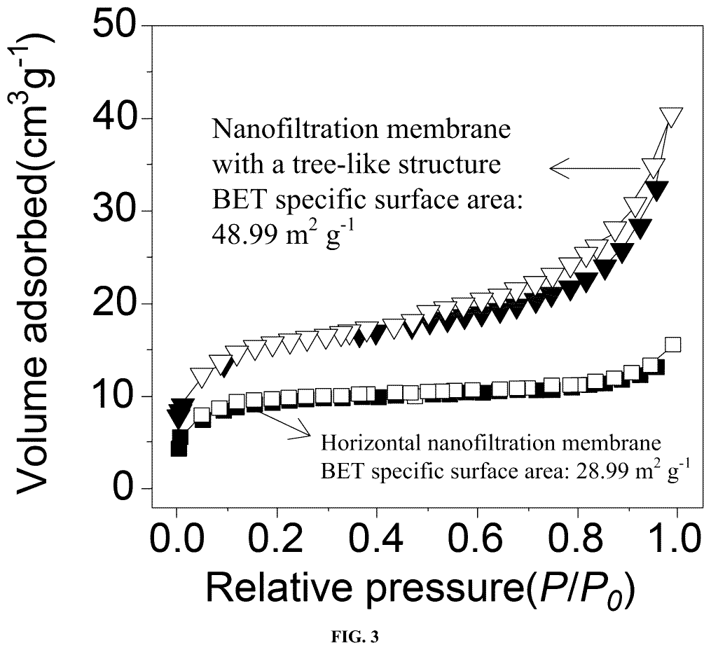

FIG. 3 shows N₂ adsorption-desorption isotherms of the nanofiltration membrane with the tree-like structure in Example 1 and the horizontal nanofiltration membrane in Comparative Example 1. It can be seen from this figure that the nanofiltration membrane with the tree-like structure has a specific surface area effectively increasing to 48.99 m² g⁻¹ and the conventional horizontal nanofiltration membrane has a specific surface area merely of 28.99 m² g⁻¹, indicating that hydroxyapatite nanowire arrays can inhibit the agglomeration of MOF nanocrystals and improve the dispersion of MOF nanocrystals, thereby significantly increasing the specific surface area. A high specific surface area can effectively promote a mass transfer process and provide increased active sites for the adsorption of pollutants.

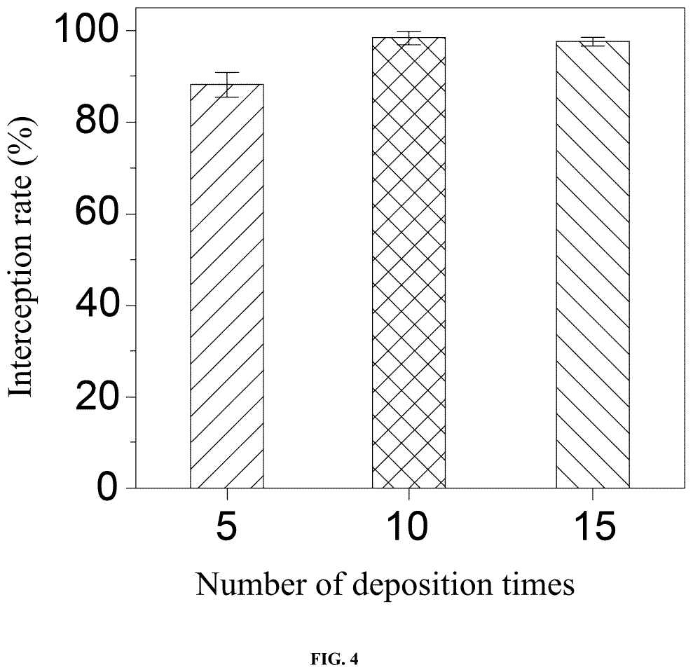

FIG. 4 shows interception rates of the nanofiltration membranes with the tree-like structure in Examples 1 to 3 for a Congo red solution. It can be seen from this figure that a number of deposition times determines a load of MOF nanocrystals and has an important impact on an interception rate, and the interception rate can reach 98.48% when the deposition is repeated 10 times.

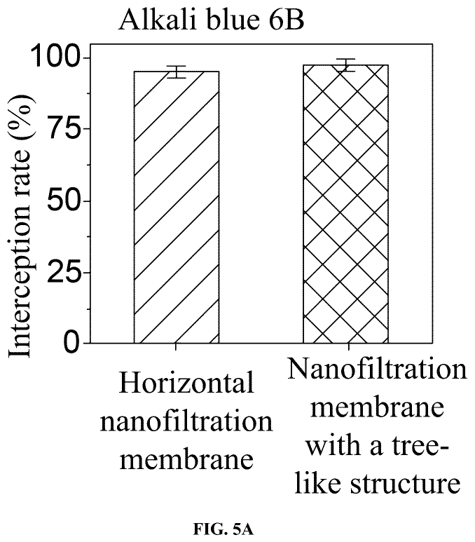

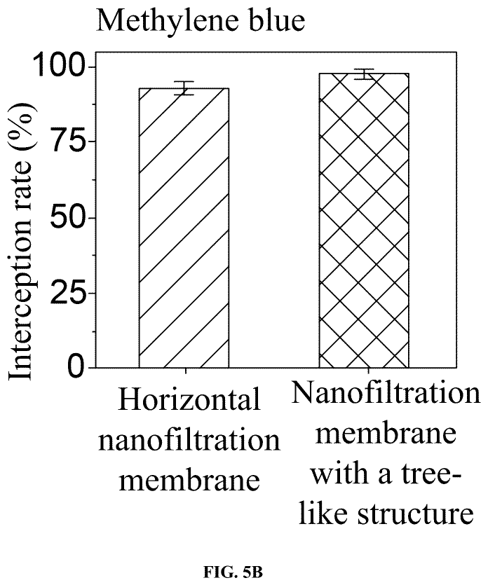

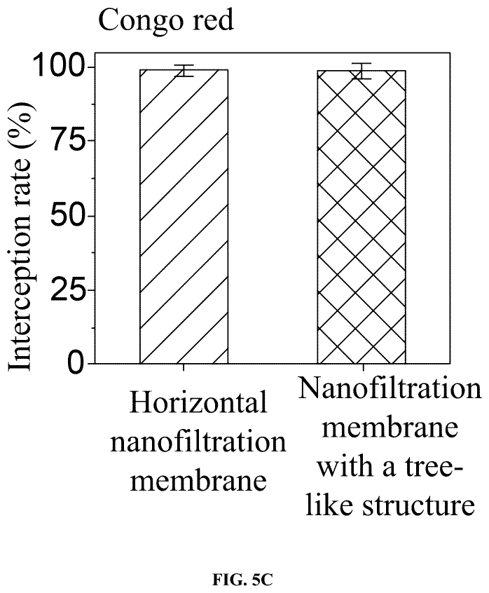

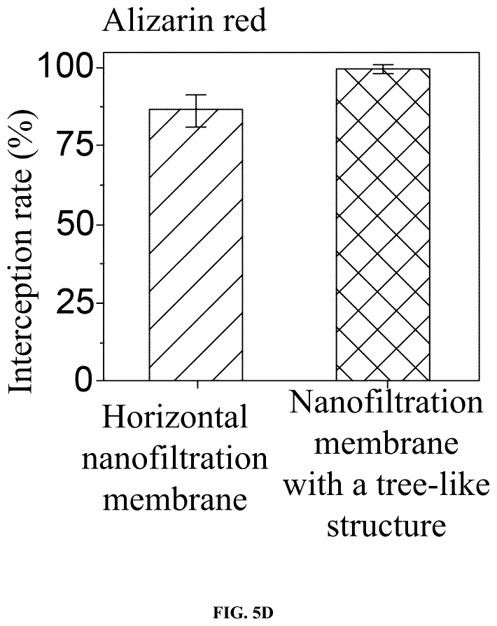

FIGS. 5A-5D show the comparison of interception rates of the nanofiltration membrane with the tree-like structure in Example 1 and the horizontal nanofiltration membrane in Comparative Example 1 for the cationic dyes of alkali blue 6B and methylene blue and the anionic dyes of Congo red and alizarin red. It can be seen from this figure that, compared with the horizontal nanofiltration membrane, dye interception rates of the nanofiltration membrane with the tree-like structure for the dyes with different properties all can reach 97% or more, indicating the superiority of the structural design. The increase in an interception rate is mainly due to a large surface roughness and a large specific surface area.

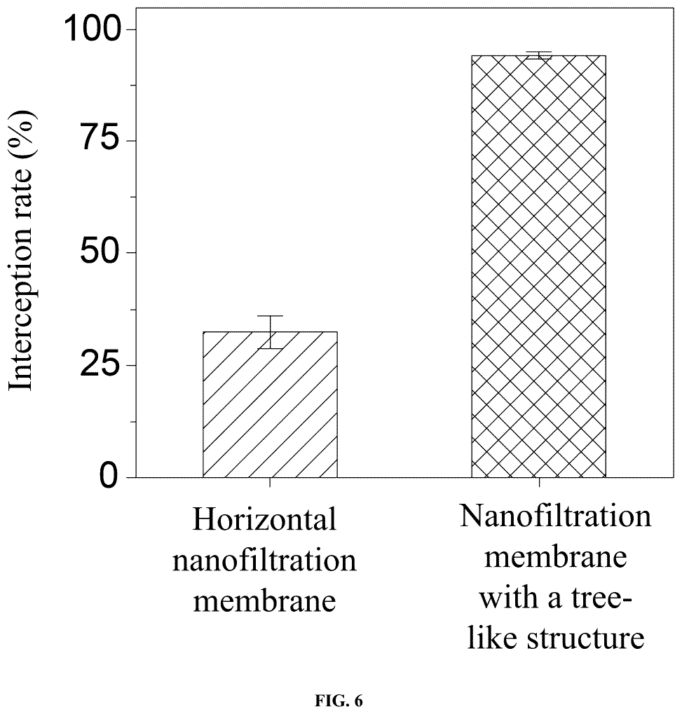

FIG. 6 shows the comparison of interception rates of the nanofiltration membrane with the tree-like structure in Example 1 and the horizontal nanofiltration membrane in Comparative Example 1 for Pb²⁺ ions. According to this figure: An interception rate of the horizontal nanofiltration membrane for Pb²⁺ ions is merely 32.66%, indicating that an interaction between MOF nanocrystals and Pb²⁺ ions is weak and Pb²⁺ ons cannot be effectively separated. An interception rate of the nanofiltration membrane with the tree-like structure for Pb²⁺ ions can reach 94.46% due to the large surface roughness and large specific surface area of the nanofiltration membrane with the tree-like structure and the excellent ion-exchange capacity of hydroxyapatite. These results show that hydroxyapatite nanowire arrays can not only effectively inhibit the agglomeration of MOF nanocrystals and improve the dispersion of MOF nanocrystals, but also provide an ion-exchange separation function, so as to make up for the poor interception of MOF nanocrystals for heavy metal ions.

The above are only preferred examples of the present disclosure, and all equivalent changes and modifications made in accordance with the claims of the present disclosure shall fall within the scope of the present disclosure.

What is claimed is:

1. A preparation method of a nanofiltration membrane with a tree-like structure, comprising the following steps:
(1) allowing hydroxyapatite nanowire arrays to grow in situ on a cellulose fiber filter paper through solvothermal synthesis to obtain a composite filter paper; and
(2) according to continuous deposition, repeatedly soaking the composite filter paper obtained in the step (1) in a metal salt and organic ligand reaction solution to obtain the tree-like structure,
wherein the cellulose fiber filter paper has a function similar to a tree root; the hydroxyapatite nanowire arrays grow vertically on the cellulose fiber filter paper, and the hydroxyapatite nanowire arrays have a function similar to a tree trunk; metal-organic framework (MOF) nanocrystals further grow on the hydroxyapatite nanowire arrays, and the MOF nanocrystals have a function similar to a tree leaf; and the high-performance nanofiltration membrane is obtained due to a tree root-tree trunk-tree leaf synergistic effect.

2. The preparation method of a nanofiltration membrane with a tree-like structure according to claim 1, wherein in the step (1), a reaction of the solvothermal synthesis is conducted at 150° C. to 250° C. for 10 h to 36 h.

3. The preparation method of a nanofiltration membrane with a tree-like structure according to claim 1, wherein in the step (1), a reaction solution adopted for the solvothermal synthesis is obtained by mixing calcium source and phosphorus source aqueous solutions with oleic acid and ethanol; a mass ratio of the oleic acid to the ethanol is 5:7; a concentration of the calcium source aqueous solution is 0.05 mol/L to 0.2 mol/L; and a concentration of the phosphorus source aqueous solution is 0.15 mol/L to 0.25 mol/L.

4. The preparation method of a nanofiltration membrane with a tree-like structure according to claim 1, wherein in the step (2), a deposition reaction of the continuous deposition is conducted 5 times to 20 times at 20° C. to 80° C. for 10 min to 60 min each time.

5. The preparation method of a nanofiltration membrane with a tree-like structure according to claim 1, wherein in the step (2), the metal salt and organic ligand reaction solution is a solution of iron chloride and trimesic acid in ethanol, and concentrations of the iron chloride and the trimesic acid both are 0.005 mol/L to 0.02 mol/L.

6. A nanofiltration membrane with a tree-like structure prepared by the preparation method according to claim 1.

7. The nanofiltration membrane with a tree-like structure according to claim 6, wherein in the step (1), a reaction of the solvothermal synthesis is conducted at 150° C. to 250° C. for 10 h to 36 h.

8. The nanofiltration membrane with a tree-like structure according to claim 6, wherein in the step (1), a reaction solution adopted for the solvothermal synthesis is obtained by mixing calcium source and phosphorus source aqueous solutions with oleic acid and ethanol; a mass ratio of the oleic acid to the ethanol is 5:7; a concentration of the calcium source aqueous solution is 0.05 mol/L to 0.2 mol/L; and a concentration of the phosphorus source aqueous solution is 0.15 mol/L to 0.25 mol/L.

9. The nanofiltration membrane with a tree-like structure according to claim 6, wherein in the step (2), a deposition reaction of the continuous deposition is conducted 5 times to 20 times at 20° C. to 80° C. for 10 min to 60 min each time.

10. The nanofiltration membrane with a tree-like structure according to claim 6, wherein in the step (2), the metal salt and organic ligand reaction solution is a solution of iron chloride and trimesic acid in ethanol, and concentrations of the iron chloride and the trimesic acid both are 0.005 mol/L to 0.02 mol/L.
